(19) United States
(12) Patent Application Publication
(10) Pub. No.: US 2023/0122357 A1
(43) Pub. Date: Apr. 20, 2023

(54) POWER SPLITTING FOR AN UPLINK TRANSMISSION USING MULTIPLE ANTENNA PANELS

(71) Applicant: QUALCOMM Incorporated, San Diego, CA (US)

(72) Inventors: Fang YUAN, Beijing (CN); Wooseok NAM, San Diego, CA (US); Tao LUO, San Diego, CA (US)

(21) Appl. No.: 17/907,045

(22) PCT Filed: Apr. 24, 2020
(86) PCT No.: PCT/CN2020/086608

§ 371 Date: Sep. 22, 2022

(51) Int. Cl. H04W 52/42; H04W 52/14

(52) U.S. Cl. CPC H04W 52/42; H04W 52/146

(57) ABSTRACT

Various aspects of the present disclosure generally relate to wireless communication. In some aspects, a user equipment (UE) may determine, for an uplink transmission that is to use multiple antenna panels, a first power splitting for a first transmit power associated with a first antenna panel of the multiple antenna panels, and a second power splitting for a second transmit power associated with a second antenna panel of the multiple antenna panels. The UE may transmit the uplink transmission using the multiple antenna panels according to the first power splitting for the first antenna panel and the second power splitting for the second antenna panel. Numerous other aspects are provided.

### FIELD OF THE DISCLOSURE

Aspects of the present disclosure generally relate to wireless communication and to techniques and apparatuses for power splitting for an uplink transmission using multiple antenna panels.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless communication network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, and/or the like.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. However, as the demand for mobile broadband access continues to increase, there exists a need for further improvements in LTE and NR technologies. Preferably, these improvements should be applicable to other multiple access technologies and the telecommunication standards that employ these technologies.

### SUMMARY

In some aspects, a method of wireless communication, performed by a UE, may include determine, for an uplink transmission that is to use multiple antenna panels, a first power splitting for a first transmit power associated with a first antenna panel of the multiple antenna panels, and a second power splitting for a second transmit power associated with a second antenna panel of the multiple antenna panels; and transmitting the uplink transmission using the multiple antenna panels according to the first power splitting for the first antenna panel and the second power splitting for the second antenna panel.

In some aspects, a UE for wireless communication may include a memory and one or more processors operatively coupled to the memory. The memory and the one or more processors may be configured to determine, for an uplink transmission that is to use multiple antenna panels, a first power splitting for a first transmit power associated with a first antenna panel of the multiple antenna panels, and a second power splitting for a second transmit power associated with a second antenna panel of the multiple antenna panels; and transmit the uplink transmission using the multiple antenna panels according to the first power splitting for the first antenna panel and the second power splitting for the second antenna panel.

In some aspects, a non-transitory computer-readable medium may store one or more instructions for wireless communication. The one or more instructions, when executed by one or more processors of a UE, may cause the one or more processors to determine, for an uplink transmission that is to use multiple antenna panels, a first power splitting for a first transmit power associated with a first antenna panel of the multiple antenna panels, and a second power splitting for a second transmit power associated with a second antenna panel of the multiple antenna panels; and transmit the uplink transmission using the multiple antenna panels according to the first power splitting for the first antenna panel and the second power splitting for the second antenna panel.

In some aspects, an apparatus for wireless communication may include means for determining, for an uplink transmission that is to use multiple antenna panels, a first power splitting for a first transmit power associated with a first antenna panel of the multiple antenna panels, and a second power splitting for a second transmit power associated with a second antenna panel of the multiple antenna panels; and means for transmitting the uplink transmission using the multiple antenna panels according to the first power splitting for the first antenna panel and the second power splitting for the second antenna panel.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communication network, in accordance with various aspects of the present disclosure.

FIG. 2 is a block diagram conceptually illustrating an example of a base station in communication with a UE in a wireless communication network, in accordance with various aspects of the present disclosure.

FIG. 3 is a diagram illustrating one or more examples of precoder matrices, in accordance with various aspects of the present disclosure.

FIGS. 4A-4E are diagrams illustrating one or more examples of power splitting for an uplink transmission using multiple antenna panels, in accordance with various aspects of the present disclosure.

FIG. 5 is a diagram illustrating an example process performed, for example, by a UE, in accordance with various aspects of the present disclosure.

### DETAILED DESCRIPTION

Various aspects of the disclosure are described hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with 3G and/or 4G wireless technologies, aspects of the present disclosure can be applied in other generation-based communication systems, such as 5G and later, including NR technologies.

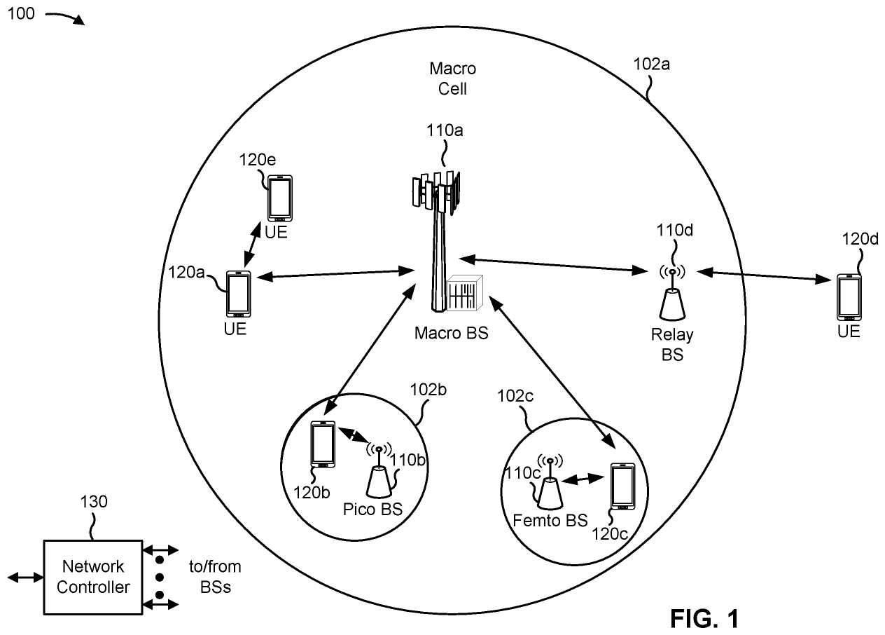

FIG. 1 is a diagram illustrating a wireless network 100 in which aspects of the present disclosure may be practiced. The wireless network 100 may be an LTE network or some other wireless network, such as a 5G or NR network. The wireless network 100 may include a number of BSs 110 (shown as BS 110a, BS 110b, BS 110c, and BS 110d) and other network entities. A BS is an entity that communicates with user equipment (UEs) and may also be referred to as a base station, a NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communication between BS 110a and UE 120d. A relay station may also be referred to as a relay BS, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each ULE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components, memory components, and/or the like. In some aspects, the processor components and the memory components may be coupled together. For example, the processor components (e.g., one or more processors) and the memory components (e.g., a memory) may be operatively coupled, communicatively coupled, electronically coupled, electrically coupled, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere herein as being performed by the base station 110.

As indicated above, FIG. 1 is provided as an example. Other examples may differ from what is described with regard to FIG. 1.

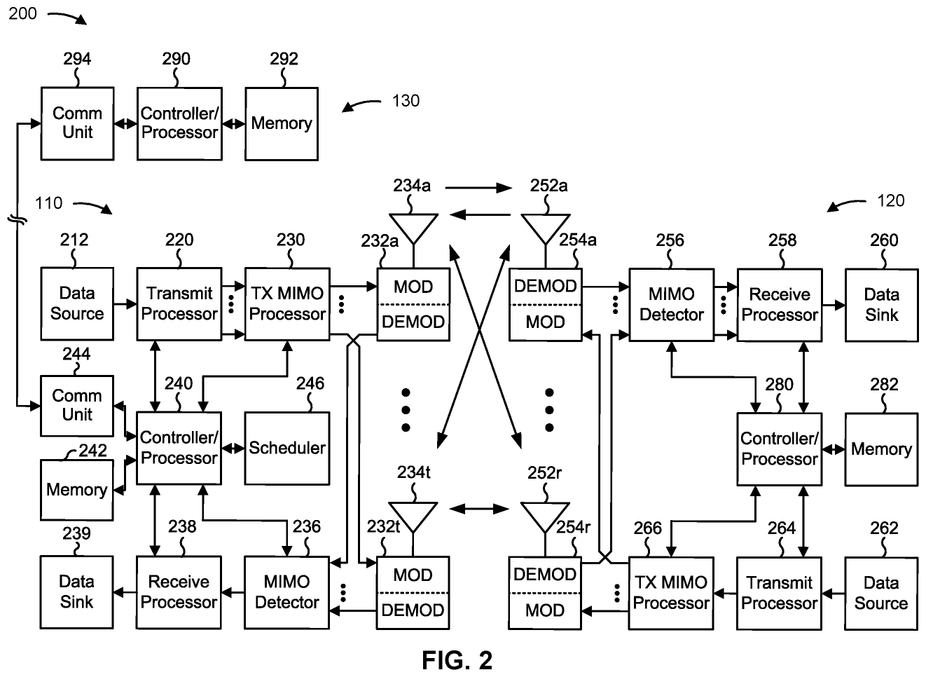

FIG. 2 shows a block diagram of a design 200 of base station 110 and UE 120, which may be one of the base stations and one of the UEs in FIG. 1. Base station 110 may be equipped with T antennas 234a through 234t, and UE 120 may be equipped with R antennas 252a through 252r, where in general T>1 and R>1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of UE 120 may be included in a housing.

Network controller 130 may include communication unit 294, controller/processor 290, and memory 292. Network controller 130 may include, for example, one or more devices in a core network. Network controller 130 may communicate with base station 110 via communication unit 294.

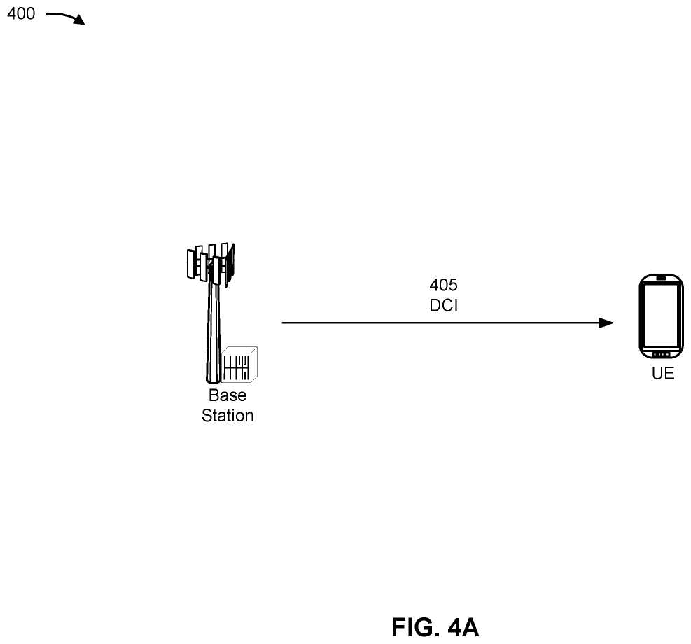

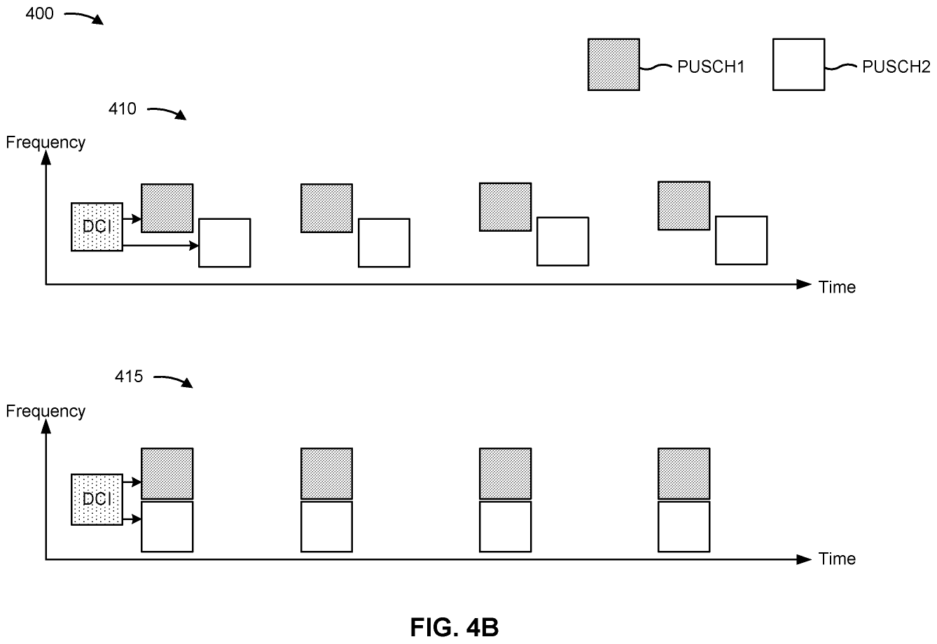

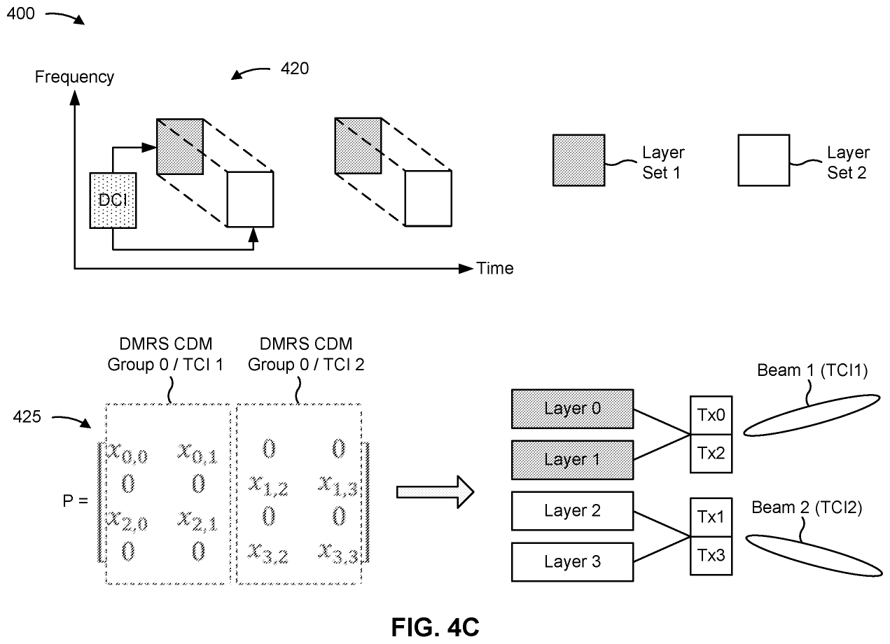

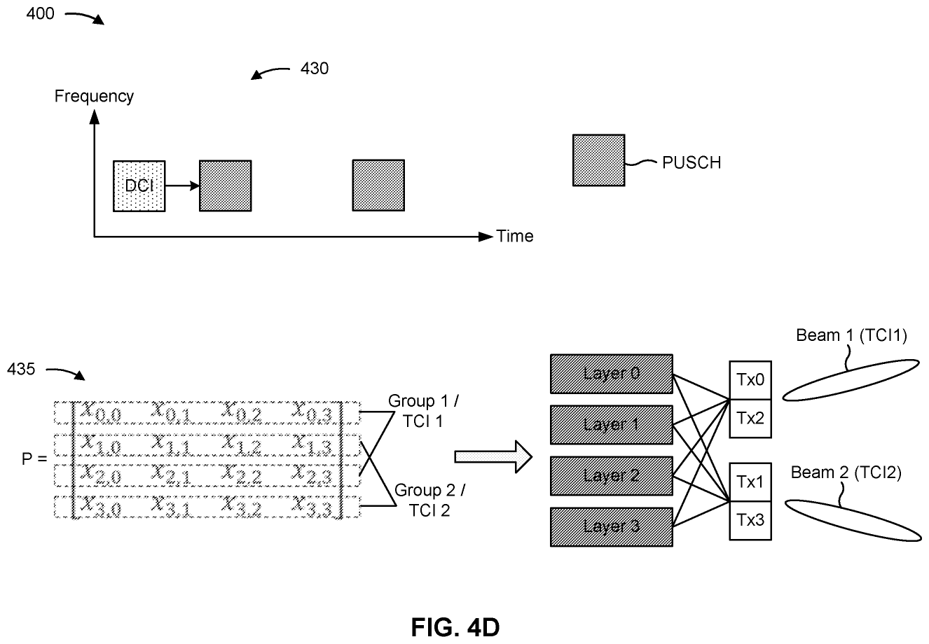

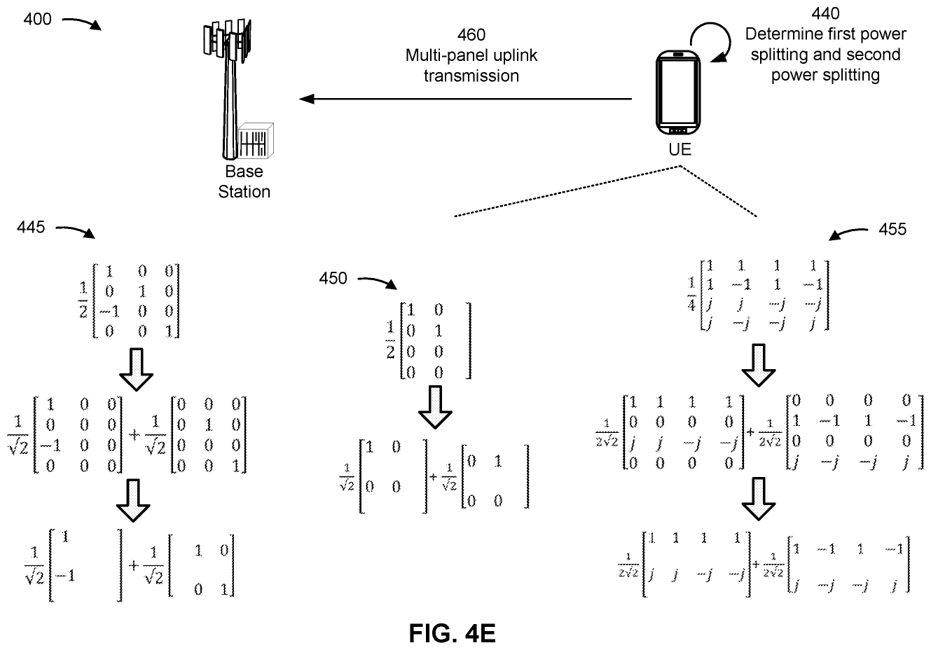

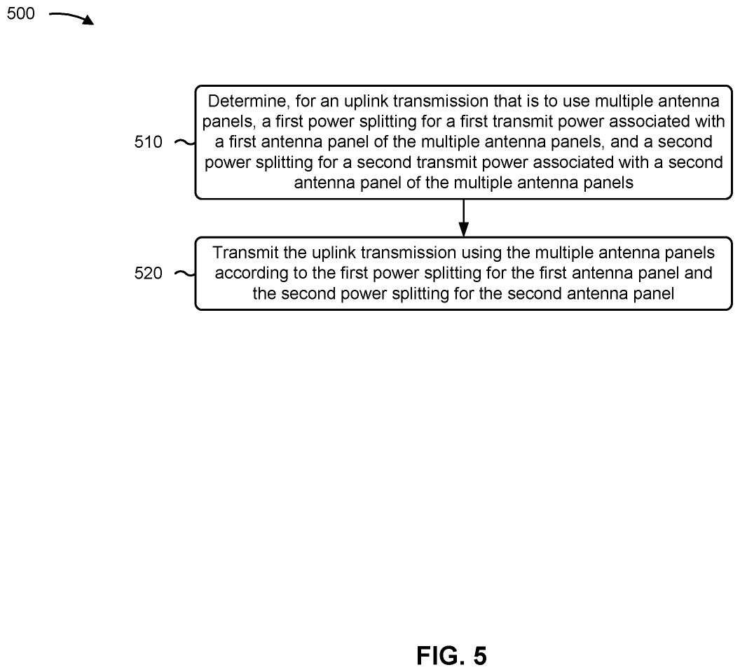

On the uplink, at UE 120, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein, for example, as described with reference to FIGS. 4A-4E and FIG. 5.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein, for example, as described with reference to FIGS. 4A-4E and FIG. 5.

Controller/processor 240 of base station 110, controller/processor 280 of UE 120, and/or any other component(s) of FIG. 2 may perform one or more techniques associated with power splitting for an uplink transmission using multiple antenna panels, as described in more detail elsewhere herein. For example, controller/processor 240 of base station 110, controller/processor 280 of UE 120, and/or any other component(s) of FIG. 2 may perform or direct operations of, for example, process 500 of FIG. 5, and/or other processes as described herein. Memories 242 and 282 may store data and program codes for base station 110 and UE 120, respectively. In some aspects, memory 242 and/or memory 282 may comprise a non-transitory computer-readable medium storing one or more instructions for wireless communication. For example, the one or more instructions, when executed (e.g., directly, or after compiling, converting, interpreting, and/or the like) by one or more processors of the base station 110 and/or the UE 120, may perform or direct operations of, for example, process 500 of FIG. 5, and/or other processes as described herein. In some aspects, executing instructions may include running the instructions, converting the instructions, compiling the instructions, interpreting the instructions, and/or the like. A scheduler 246 may schedule UEs for data transmission on the downlink and/or uplink.

In some aspects, UE 120 may include means for determining, for an uplink transmission that is to use multiple antenna panels, a first power splitting for a first transmit power associated with a first antenna panel of the multiple antenna panels, and a second power splitting for a second transmit power associated with a second antenna panel of the multiple antenna panels, means for transmitting the uplink transmission using the multiple antenna panels according to the first power splitting for the first antenna panel and the second power splitting for the second antenna panel, and/or the like. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, receive processor 258, and/or the like.

As indicated above, FIG. 2 is provided as an example. Other examples may differ from what is described with regard to FIG. 2.

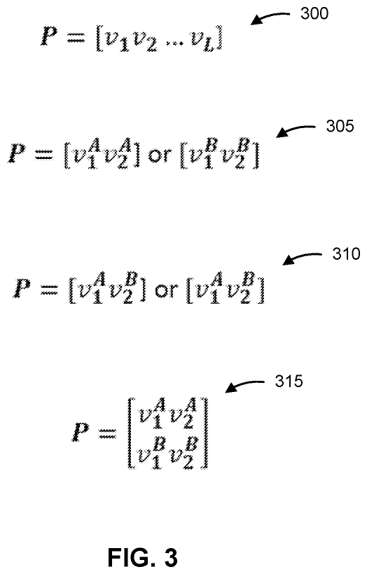

FIG. 3 is a diagram illustrating one or more examples of precoder matrices, in accordance with various aspects of the present disclosure. In some aspects, a UE may be configured or otherwise provisioned with one or more precoder matrices. A precoder matrix that the UE is to use for an uplink transmission may be indicated to a UE (e.g., in downlink control information (DCI)) by a transmit precoder matrix indicator (TPMI).

Example 300 shows a precoder matrix (P) for single panel transmission using multiple transmission layers. In example 300, v₁ represents a precoder for a first layer, v₂ represents a precoder for a second layer, and v_{L} represents a precoder for a layer L.

Example 305 shows precoder matrices (P) for a transmission using dynamic panel selection. In example 305, v₁^{A} represents a precoder for a first layer for a first antenna panel (A), v₂^{A} represents a precoder for a second layer for the first antenna panel (A), v₁^{B} represents a precoder for a first layer for a second antenna panel (B), and v₂^{B} represents a precoder for a second layer for the second antenna panel (B). Accordingly, a transmission using dynamic panel selection may be a multiple layer transmission in which each layer is transmitted using the same antenna panel that is dynamically selected (e.g., in DCI). The antenna panel may include a group of antenna ports, and may be identified by an explicit panel identifier or an implicit resource identifier, such as a reference signal identifier, a transmission configuration indicator (TCI) identifier, and/or the like.

Example 310 shows precoder matrices (P) for a non-coherent joint transmission (e.g., a transmission using spatial division multiplexing (SDM)). In example 310, v₁^{A} represents a precoder for a first layer for a first antenna panel (A), and v₁^{B} represents a precoder for a second layer for a second antenna panel (B). Accordingly, a non-coherent joint transmission may be a multiple layer transmission in which each layer is transmitted using a respective antenna panel.

Example 315 shows a precoder matrix (P) for joint transmission (e.g., an aggregated panel transmission). In example 315, v₁^{A} represents a precoder for a first layer for a first antenna panel (A), v₂^{A} represents a precoder for a second layer for the first antenna panel (A), v₁^{B} represents a precoder for the first layer for a second antenna panel (B), and v₂^{B} represents a precoder for the second layer for the second antenna panel (B). Accordingly, a joint transmission may be a multiple layer transmission in which each layer is transmitted using multiple antenna panels.

As indicated above, FIG. 3 is provided as an example. Other examples may differ from what is described with regard to FIG. 3.

In some wireless networks, a UE may perform an uplink transmission using a single antenna panel by splitting an uplink transmit power of the UE among physical uplink shared channel (PUSCH) antenna ports of the single antenna panel. As described above, in some wireless networks, a UE may perform an uplink transmission using multiple antenna panels. However, wireless networks generally lack support for techniques that enable a UE to determine a power splitting that is to be used for an uplink transmission using multiple antenna panels.

Some techniques and apparatuses described herein provide for power splitting for an uplink transmission using multiple antenna panels. For example, in some aspects, a UE may determine a first power splitting for a first transmit power associated with a first antenna panel of the multiple antenna panels, and a second power splitting for a second transmit power associated with a second antenna panel of the multiple antenna panels. Accordingly, the UE may perform an uplink transmission using the multiple antenna panels according to the first power splitting for the first antenna panel and the second power splitting for the second antenna panel.

FIGS. 4A-4E are diagrams illustrating one or more examples 400 of power splitting for an uplink transmission using multiple antenna panels, in accordance with various aspects of the present disclosure. As shown in FIGS. 4A and 4E, a UE (e.g., a UE 120) and a base station (e.g., a BS 110) may communicate with one another. In some aspects, the UE may employ a plurality of transmit antenna panels (e.g., a plurality of PUSCH antenna port groups). In some aspects, the UE may communicate with a plurality of TRPs (e.g., a plurality of antenna panels) associated with the base station. In some aspects, the plurality of TRPs may be associated with more than one base station.

As shown in FIG. 4A, and by reference number 405, the base station may transmit, and the UE may receive, DCI. The DCI may schedule an uplink transmission of the UE that is to use multiple antenna panels (i.e., a multi-panel uplink transmission). In some aspects, the DCI may indicate one or more transmit power control (TPC) commands, one or more additional parameters (e.g., one or more closed loop index values, and/or the like), and/or the like, which may be used by the UE for calculating per-panel transmit powers for the multi-panel uplink transmission.

In some aspects, the DCI may indicate (e.g., using a TPMI) a precoder matrix that is to be used for the multi-panel uplink transmission. Moreover, the DCI may provide respective beam indications for the multiple antenna panels. For example, the DCI may indicate respective TCI states, respective sounding reference signal (SRS) resource indicators (SRIs), respective SRS resource set indicators, and/or the like, for the multiple antenna panels. In addition, the DCI may indicate one or more demodulation reference signal (DMRS) identifiers (e.g., one or more DMRS port group identifiers). For example, the DCI may indicate one or more DMRS identifiers that identify DMRS ports associated with multiple DMRS code division multiplexing (CDM) groups.

As shown in FIG. 4B, and by reference number 410, in some aspects, the DCI may schedule a multi-panel uplink transmission that uses time division multiplexing (TDM). For example, the DCI may schedule a first transmission (PUSCH1) on a first antenna panel (e.g., associated with one or more first PUSCH antenna ports) of the UE, and a second transmission (PUSCH2) on a second antenna panel (e.g., associated with one or more second PUSCH antenna ports) of the UE. The first transmission and the second transmission may use TDM, such that a time domain resource allocation for the first transmission and a time domain resource allocation for the second transmission (e.g., as indicated in the DCI) do not overlap.

As shown by reference number 415, in some aspects, the DCI may schedule a multi-panel uplink transmission that uses frequency division multiplexing (FDM). For example, the DCI may schedule a first transmission (PUSCH1) on a first antenna panel (e.g., associated with one or more first PUSCH antenna ports) of the UE, and a second transmission (PUSCH2) on a second antenna panel (e.g., associated with one or more second PUSCH antenna ports) of the UE. The first transmission and the second transmission may use FDM, such that a frequency domain resource allocation for the first transmission and a frequency domain resource allocation for the second transmission (e.g., as indicated in the DCI) do not overlap.

In some aspects, the DCI (or other higher-layer signaling, such as radio resource control (RRC) signaling) may schedule multiple repetitions of the first transmission and the second transmission. A repetition may be referred to as a PUSCH occasion. Accordingly, repetitions of the first transmission (e.g., on the first antenna panel) may form a first set of PUSCH occasions, and repetitions of the second transmission (e.g., on the second antenna panel) may form a second set of PUSCH occasions.

In some aspects, the DCI may identify the first set of PUSCH occasions and the second set of PUSCH occasions using respective time domain resource allocations (e.g., for TDM) or respective frequency domain resource allocations (e.g., for FDM). In some aspects, the DCI may identify the first set of PUSCH occasions and second set of PUSCH occasions using respective beam indications (e.g., respective TCI identifiers, SRIs, SRS resource set indicators, and/or the like) associated with respective antenna panels. In some aspects, the DCI may identify the first set of PUSCH occasions and the second set of PUSCH occasions using respective power control closed loop index values (e.g., a first closed loop index value may be associated with a first antenna panel, and a second closed loop index value may be associated with a second antenna panel).

As shown in FIG. 4C, and by reference number 420, in some aspects, the DCI may schedule a multi-panel uplink transmission that is a non-coherent joint transmission. For example, the DCI may schedule a first transmission using a first layer set (Layer Set 1) on a first antenna panel of the UE, and a second transmission using a second layer set (Layer Set 2) on a second antenna panel of the UE. The first transmission and the second transmission may use SDM. That is, a time domain and a frequency domain resource allocation for the first transmission and the second transmission is the same (e.g., overlap). Moreover, as shown, the DCI (or other higher-layer signaling) may schedule multiple repetitions of the non-coherent joint transmission.

In some aspects, the DCI may indicate (e.g., using a TPMI) a precoder matrix (P) that is to be used for the non-coherent joint transmission. For example, the DCI may indicate precoder matrix 425, in which a first layer (Layer 0) and a second layer (Layer 1) include precoders (e.g., non-zero power values) for a first PUSCH antenna port (Tx0) and a third PUSCH antenna port (Tx2), and a third layer (Layer 2) and a fourth layer (Layer 3) include precoders (e.g., non-zero power values) for a second PUSCH antenna port (Tx1) and a fourth PUSCH antenna port (Tx3) (e.g., a first set of layers is mapped to a first group of PUSCH antenna ports and a second set of layers is mapped to a second group of PUSCH antenna ports). As shown, a first DMRS CDM group (DMRS CDM Group 0) may be mapped to the first and second layers (Layers 0 and 1), and a second DMRS CDM group (DMRS CDM Group 1) may be mapped to the third and fourth layers (Layers 2 and 3). The first DMRS CDM group may be associated with a first beam indication (TCI 1) and the second DMRS CDM group may be associated with a second beam indication (TCI 2).

Accordingly, as shown, a first antenna panel of the UE may be associated with a first set of layers (Layer Set 1, i.e., Layers 0 and 1) that are associated with a first group of PUSCH antenna ports (Tx0 and Tx2) and a first beam (Beam 1). Additionally, as shown, a second antenna panel of the UE may be associated with a second set of layers (Layer Set 2, i.e., Layers 2 and 3) that are associated with a second group of PUSCH antenna ports (T×l and Tx3) and a second beam (Beam 2).

In some aspects, the DCI may identify the first set of layers and the second set of layers using respective DMRS port group identifiers (e.g., the first set of layers is associated with a first DMRS port group, and the second set of layers is associated with a second DMRS port group). In some aspects, the DCI may identify the first set of layers and second set of layers using respective beam indications and/or respective power control closed loop index values, as described above.

As shown in FIG. 4D, and by reference number 430, in some aspects, the DCI may schedule a multi-panel uplink transmission that is a joint transmission (e.g., a coherent joint transmission). For example, the DCI may schedule a transmission (PUSCH) on a first antenna panel and a second antenna panel of the UE. Moreover, as shown, the DCI (or other higher-layer signaling) may schedule multiple repetitions of the joint transmission.

In some aspects, the DCI may indicate (e.g., using a TPMI) a precoder matrix (P) that is to be used for the joint transmission. For example, the DCI may indicate precoder matrix 435, in which a first layer (Layer 0), a second layer (Layer 1), a third layer (Layer 2), and a fourth layer (Layer 3) include precoders (e.g., non-zero power values) for a first PUSCH antenna port (Tx0), a second PUSCH antenna port (Tx1), a third PUSCH antenna port (Tx2), and a fourth PUSCH antenna port (Tx3) (e.g., each of the layers is mapped to all of the PUSCH antenna ports). As shown, a first group of PUSCH antenna ports (Tx0 and Tx2) may be associated with a first beam indication (TCI 1), and a second group of PUSCH antenna ports (Tx1 and Tx3) may be associated with a second beam indication (TCI 2).

Accordingly, as shown, a first antenna panel of the UE may be associated with a first group of PUSCH antenna ports (Tx0 and Tx2) and a first beam (Beam 1). Additionally, as shown, a second antenna panel of the UE may be associated with a second group of PUSCH antenna ports (T×l and Tx3) and a second beam (Beam 2).

In some aspects, the UE may be configured with an indication of the first group of PUSCH antenna ports and the second group of PUSCH antenna ports. For example, the indication may indicate that one or more first antenna ports (e.g., Tx0 and Tx2) are to be the first group of PUSCH antenna ports (associated with a first group identifier) and one or more second antenna ports (e.g., Tx1 and Tx3) are to be the second group of PUSCH antenna ports (associated with a second group identifier). In some aspects, the first group of PUSCH antenna ports and the second group of PUSCH antenna ports may be associated with (e.g., as indicated by DCI or other higher-layer signaling, or as configured or provisioned for the UE) respective beam indications and/or respective power control closed loop index values, as described above.

As shown in FIG. 4E, and by reference number 440, the UE may determine a first power splitting for a first uplink transmit power (e.g., a first PUSCH transmit power) associated with a first antenna panel of the multiple antenna panels of the UE, and a second power splitting for a second uplink transmit power (e.g., a second PUSCH transmit power) associated with a second antenna panel of the multiple antenna panels of the UE. That is, power splitting for the multi-panel uplink transmission may be per antenna panel.

In some aspects, the UE may determine the first uplink transmit power associated with the first antenna panel and the second uplink transmit power associated with the second antenna panel (e.g., according to a TPC command and/or one or more other parameters, such as a closed loop index value, indicated in the DCI). In some aspects, if the UE is to transmit a PUSCH on an active uplink bandwidth part (BWP) b, of a carrier f, of a serving cell c, using a parameter set configuration with index j, and a PUSCH power control adjustment state with index 1, the UE may determine an uplink transmit power for an antenna panel in a PUSCH transmission occasion i according to the following equation:

$${P}_{PUSCH} ( i , j , {q}_{d} , l ) = min ( \begin{matrix}{P}_{cmax , f , c ( i )} \\ \begin{matrix}{P}_{{o}_{PUSCH} , b , f , c} ( j ) + 10 {log}_{10} ( {2}^{μ} {M}_{RB , b , f , c}^{PUSCH} ( i ) ) + \\ {α}_{b , f , c ,} ( j ) {PL}_{b , f , c} ( {q}_{d} ) + {Δ}_{TF , f , c} ( i ) + {f}_{b , f , c} ( i , l )\end{matrix}\end{matrix} )$$

where P_{PUSCH}(i, j, q_{d}, l) represents the uplink transmit power; Pₒ_{_{PUSCH}}_{,b,f,c} represents a target signal to interference plus noise ratio (SINR) determined by P0 value; M_{RB,b,f,c}^{PUSCH}(i) represents a bandwidth of the PUSCH resource assignment for the PUSCH transmission expressed as a quantity of resource blocks; α_{b,f,c}, represents a path loss compensation factor; PL_{b,f,c} represents a path loss downlink reference signal; Δ_{TF,f,c} represents an MCS-related adjustment; and f_{b,f,c} represents a PUSCH power control adjustment state with a closed loop index l. In some aspects, an uplink transmit power determined by the UE may be subject to (e.g., reduced to) a maximum transmit power limitation.

In some aspects, the first uplink transmit power and the second uplink transmit power may be indicated as the same (e.g., equal). In some aspects, the first uplink transmit power and the second uplink transmit power may be indicated as different (e.g., nonequal). In some aspects, the UE may determine the first power splitting for the first transmit power and the second power splitting for the second transmit power based at least in part on a type of the multi-panel uplink transmission scheduled by the DCI.

In some aspects, the DCI schedules one or more repetitions of multi-panel uplink transmissions that use TDM or FDM (as described above in connection with FIG. 4B). In this case, power splitting may be among PUSCH antenna ports in each PUSCH occasion per set of PUSCH occasions. For example, the UE may determine that the first power splitting is to split the first uplink transmit power among (e.g., equally among) one or more PUSCH antenna ports used for a first set of PUSCH occasions and the second power splitting is to split the second uplink transmit power among (e.g., equally among) one or more PUSCH antenna ports used for a second set of PUSCH occasions.

As described above, the first set of PUSCH occasions may include one or more transmissions that are to use a first antenna panel of the UE and the second set of PUSCH occasions may include one or more transmissions that are to use a second antenna panel of the UE (e.g., the first set of PUSCH occasions may be time division multiplexed or frequency division multiplexed with the second set of PUSCH occasions). Accordingly, the UE may determine that a transmission in a PUSCH occasion associated with the first set of PUSCH occasions is to be performed according to the first power splitting, and a transmission in a PUSCH occasion associated with the second set of PUSCH occasions is to be performed according to the second power splitting.

In some aspects, the first power splitting among the PUSCH antenna port(s) used for the first set of PUSCH occasions, and the second power splitting among the PUSCH antenna port(s) used for the second set of PUSCH occasions, is not the same (e.g., is nonequal). For example, a transmit power that is to be used for a single PUSCH antenna port used for the first set of PUSCH occasions may be expressed as s₀\hat{P}_{PUSCH,0}, where \hat{P}_{PUSCH,0} represents a linear value of the first transmit power and so represents a first power scaling value used for the first set of PUSCH occasions. Similarly, a transmit power that is to be used for a single PUSCH antenna port used for the second set of PUSCH occasions may be expressed as s₁\hat{P}_{PUSCH,1}, where \hat{P}_{PUSCH,1} represents a linear value of the second transmit power and s₁ represents a second power scaling value used for the second set of PUSCH occasions.

Accordingly, in some aspects, the UE may determine different values for the first power scaling value (so) and the second power scaling value (s₁). For example, the UE may determine a power scaling value (s) as a ratio of a quantity of antenna ports with non-zero PUSCH transmission power to a maximum quantity of SRS ports supported by the UE in one SRS resource (e.g., if an uplink full power transmission (ULFPTx) mode of the UE is set to Mode 1, and/or if each SRS resource in an SRS resource set of the UE, associated with codebook usage, includes more than one SRS port). As another example, the UE may determine that a power scaling value (s) is equal to one for a TPMI reported as full power by the UE (e.g., if an ULFPTx mode of the UE is set to Mode 2). In this example, a TPMI that is not reported as full power may be associated with a power scaling value (s) that is a ratio of a quantity of antenna ports with non-zero PUSCH transmission power to a quantity of SRS ports associated with an SRS resource indicated by an SRI (or the only SRS resource in an SRS resource set associated with codebook usage). As a further example, the UE may determine that a power scaling value (s) is equal to one when an ULFPTx mode of the UE is not configured.

In some aspects, the DCI schedules one or more repetitions of a non-coherent joint transmission (as described above in connection with FIG. 4C). In this case, power splitting may be among PUSCH antenna ports per layer set in each PUSCH occasion. For example, the UE may determine that the first power splitting is to split the first uplink transmit power among (e.g., equally among) one or more PUSCH antenna ports associated with a first set of layers used for a PUSCH occasion (e.g., of the one or more repetitions) and the second power splitting is to split the second uplink transmit power among (e.g., equally among) one or more PUSCH antenna ports associated with a second set of layers used for the PUSCH occasion.

In some aspects, the first power splitting among the PUSCH antenna port(s) associated with the first set of layers, and the second power splitting among the PUSCH antenna port(s) associated with the second set of layers, is not the same (e.g., is nonequal). For example, a transmit power that is to be used for a single PUSCH antenna port associated with the first set of layers may be expressed as s₀\hat{P}_{PUSCH,0}, and a transmit power that is to be used for a single PUSCH antenna port associated with the second set of layers may be expressed as s₁\hat{P}_{PUSCH,1}, as described above. Accordingly, in some aspects, the UE may determine different values for a first power scaling value (s₀) and a second power scaling value (s₁), as described above.

In some aspects, as illustrated by examples 445 and 450, the UE may determine sub-precoder matrices (e.g., sub-TPMIs) of a precoder matrix used for non-coherent joint transmission. For example, the UE may determine a first sub-precoder matrix for the first set of layers (e.g., in which precoders for the second set of layers have zero power values), and a second sub-precoder matrix for the second set of layers (e.g., in which precoders for the first set of layers have zero power values). In this case, the UE may determine (and use) the first power scaling value (s₀) for the first sub-precoder matrix and the second power scaling value (s₁) for the second sub-precoder matrix. For example, the UE may determine values of s₀ and s₁ based at least in part on a quantity of PUSCH antenna ports in a group of PUSCH antenna ports and a quantity of layers used for a PUSCH occasion. In the example 445, the UE may equally split a transmit power among the PUSCH antenna ports and the layers in a PUSCH occasion, and thus the value of s₀ and s₁ can be

$${( \frac{1}{\sqrt{2}} )}^{2} .$$

In the example 450, the UE may equally split a transmit power among the PUSCH antenna ports and the layers in a PUSCH occasion, and depending on a full power transmission mode indicated to the UE, the value of s₀ and s₁ can be either

$${( \frac{1}{\sqrt{2}} )}^{2}$$

or 1. In some aspects, PUSCH antenna ports that are not associated with a set of layers for a sub-precoder matrix may be removed from the sub-precoder matrix.

In some aspects, the DCI schedules one or more repetitions of a joint transmission (as described above in connection with FIG. 4D). In this case, power splitting may be among PUSCH antenna ports per group of PUSCH antenna ports in each PUSCH occasion. For example, the UE may determine that the first power splitting is to split the first uplink transmit power among (e.g., equally among) one or more PUSCH antenna ports associated with a first group of PUSCH antenna ports used for a PUSCH occasion (e.g., of the one or more repetitions) and the second power splitting is to split the second uplink transmit power among (e.g., equally among) one or more PUSCH antenna ports associated with a second group of PUSCH antenna ports used for the PUSCH occasion.

In some aspects, the first power splitting among the PUSCH antenna port(s) associated with the first group of PUSCH antenna ports, and the second power splitting among the PUSCH antenna port(s) associated with the second group of PUSCH antenna ports, is not the same (e.g., is nonequal). For example, a transmit power that is to be used for a single PUSCH antenna port associated with the first group of PUSCH antenna ports may be expressed as s₀\hat{P}_{PUSCH,0}, and a transmit power that is to be used for a single PUSCH antenna port associated with the second group of PUSCH antenna ports may be expressed as s₁\hat{P}_{PUSCH,1}, as described above. Accordingly, in some aspects, the UE may determine different values for a first power scaling value (so) and a second power scaling value (s₁), as described above.

In some aspects, as illustrated by example 455, the UE may determine sub-precoder matrices (e.g., sub-TPMIs) of a precoder matrix used for joint transmission. For example, the UE may determine a first sub-precoder matrix for the first group of PUSCH antenna ports (e.g., in which precoders for the second group of PUSCH antenna ports have zero power values), and a second sub-precoder matrix for the second group of PUSCH antenna ports (e.g., in which precoders for the first group of PUSCH antenna ports have zero power values). In this case, the UE may determine (and use) the first power scaling value (so) for the first sub-precoder matrix and the second power scaling value (s₁) for the second sub-precoder matrix. For example, the UE may determine values of s₀ and s₁ based at least in part on a quantity of PUSCH antenna ports in a group of PUSCH antenna ports and a quantity of layers used for a PUSCH occasion. In the example 455, there are two PUSCH antenna ports in a group of PUSCH antenna ports and four layers in a PUSCH occasion. Accordingly, the UE may equally split a transmit power among the PUSCH antenna ports and the layers in a PUSCH occasion, and thus the value of s₀ and s₁ can be

$${( \frac{1}{2 \sqrt{2}} )}^{2} = \frac{1}{8} .$$

In some aspects, PUSCH antenna ports that are not associated with a group of PUSCH antenna ports for a sub-precoder matrix may be removed from the sub-precoder matrix.

As shown by reference number 460, the UE may transmit, and the base station may receive, the multi-panel uplink transmission (e.g., according to the DCI). That is, the UE may perform uplink transmissions using TDM or FDM, perform an uplink non-coherent joint transmission, or perform an uplink joint transmission, using multiple antenna panels and multiple beams. For example, the UE may transmit the multi-panel uplink transmission using a first transmit power, for a first antenna panel, that is split (e.g., equally among PUSCH antenna ports, on which the UE is to transmit, associated with non-zero power) according to the first power splitting, and using a second transmit power, for a second antenna panel, that is split (e.g., equally among PUSCH antenna ports, on which the UE is to transmit, associated with non-zero power) according to the second power splitting. In some aspects, the UE 120 may transmit the multi-panel transmission to a first TRP (e.g., associated with the base station) and a second TRP (e.g., associated with the base station or another base station).

As indicated above, FIGS. 4A-4E are provided as one or more examples. Other examples may differ from what is described with regard to FIGS. 4A-4E.

FIG. 5 is a diagram illustrating an example process 500 performed, for example, by a UE, in accordance with various aspects of the present disclosure. Example process 500 is an example where the UE (e.g., UE 120 and/or the like) performs operations associated with power splitting for an uplink transmission using multiple antenna panels.

As shown in FIG. 5, in some aspects, process 500 may include determining, for an uplink transmission that is to use multiple antenna panels, a first power splitting for a first transmit power associated with a first antenna panel of the multiple antenna panels, and a second power splitting for a second transmit power associated with a second antenna panel of the multiple antenna panels (block 510). For example, the UE (e.g., using transmit processor 264, controller/processor 280, memory 282, and/or the like) may determine, for an uplink transmission that is to use multiple antenna panels, a first power splitting for a first transmit power associated with a first antenna panel of the multiple antenna panels, and a second power splitting for a second transmit power associated with a second antenna panel of the multiple antenna panels, as described above.

As further shown in FIG. 5, in some aspects, process 500 may include transmitting the uplink transmission using the multiple antenna panels according to the first power splitting for the first antenna panel and the second power splitting for the second antenna panel (block 520). For example, the UE (e.g., using controller/processor 280, transmit processor 264, TX MIMO processor 266, MOD 254, antenna 252, and/or the like) may transmit the uplink transmission using the multiple antenna panels according to the first power splitting for the first antenna panel and the second power splitting for the second antenna panel, as described above.

Process 500 may include additional aspects, such as any single aspect or any combination of aspects described below and/or in connection with one or more other processes described elsewhere herein.

In a first aspect, the first transmit power and the second transmit power are equal. In a second aspect, the first transmit power and the second transmit power are not equal.

In a third aspect, alone or in combination with one or more of the first and second aspects, the first transmit power is determined to be split among one or more first PUSCH antenna ports that are to be used for a first set of PUSCH occasions, and the second transmit power is determined to be split among one or more second PUSCH antenna ports that are to be used for a second set of PUSCH occasions. In a fourth aspect, alone or in combination with one or more of the first through third aspects, the first set of PUSCH occasions are time division multiplexed or frequency division multiplexed with the second set of PUSCH occasions. In a fifth aspect, alone or in combination with one or more of the first through fourth aspects, the first transmit power is determined to be split equally among the one or more first PUSCH antenna ports, and the second transmit power is determined to be split equally among the one or more second PUSCH antenna ports.

In a sixth aspect, alone or in combination with one or more of the first through fifth aspects, the first set of PUSCH occasions is associated with at least one of a first time division resource allocation, a first frequency division resource allocation, a first beam indication, or a first closed loop index, and the second set of PUSCH occasions is associated with at least one of a second time division resource allocation, a second frequency division resource allocation, a second beam indication, or a second closed loop index.

In a seventh aspect, alone or in combination with one or more of the first through sixth aspects, the first transmit power is determined to be split among one or more first PUSCH antenna ports associated with a first set of layers used for a PUSCH occasion, and the second transmit power is determined to be split among one or more second PUSCH antenna ports associated with a second set of layers used for the PUSCH occasion. In an eighth aspect, alone or in combination with one or more of the first through seventh aspects, the first set of layers and the second set of layers are used for a non-coherent joint transmission of the uplink transmission in the PUSCH occasion. In a ninth aspect, alone or in combination with one or more of the first through eighth aspects, the first transmit power is determined to be split equally among the one or more first PUSCH antenna ports, and the second transmit power is determined to be split equally among the one or more second PUSCH antenna ports.

In a tenth aspect, alone or in combination with one or more of the first through ninth aspects, the first set of layers is associated with at least one of a first DMRS port group, a first beam indication, or a first closed loop index, and the second set of layers is associated with at least one of a second DMRS port group, a second beam indication, or a second closed loop index. In an eleventh aspect, alone or in combination with one or more of the first through tenth aspects, a first power scaling value is associated with the first set of layers, and a second power scaling value is associated with the second set of layers.

In a twelfth aspect, alone or in combination with one or more of the first through eleventh aspects, the first transmit power is determined to be split among one or more first PUSCH antenna ports associated with a first group of PUSCH antenna ports used for a PUSCH occasion, and the second transmit power is determined to be split among one or more second PUSCH antenna ports associated with a second group of PUSCH antenna ports used for the PUSCH occasion. In a thirteenth aspect, alone or in combination with one or more of the first through twelfth aspects, the first group of PUSCH antenna ports and the second group of PUSCH antenna ports are used for a joint transmission of the uplink transmission in the PUSCH occasion. In a fourteenth aspect, alone or in combination with one or more of the first through thirteenth aspects, the first transmit power is determined to be split equally among the one or more first PUSCH antenna ports, and the second transmit power is determined to be split equally among the one or more second PUSCH antenna ports.

In a fifteenth aspect, alone or in combination with one or more of the first through fourteenth aspects, the first group of PUSCH antenna ports is associated with at least one of a first PUSCH antenna port group identifier, a first beam indication, or a first closed loop index, and the second group of PUSCH antenna ports is associated with at least one of a second PUSCH antenna port group identifier, a second beam indication, or a second closed loop index. In a sixteenth aspect, alone or in combination with one or more of the first through fifteenth aspects, a first power scaling value is associated with the first group of PUSCH antenna ports, and a second power scaling value is associated with the second group of PUSCH antenna ports.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software.

As used herein, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items, and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

1. A method of wireless communication performed by a user equipment (UE), comprising:
determine, for an uplink transmission that is to use multiple antenna panels, a first power splitting for a first transmit power associated with a first antenna panel of the multiple antenna panels, and a second power splitting for a second transmit power associated with a second antenna panel of the multiple antenna panels; and
transmitting the uplink transmission using the multiple antenna panels according to the first power splitting for the first antenna panel and the second power splitting for the second antenna panel.

2. The method of claim 1, wherein the first transmit power and the second transmit power are equal.

3. The method of claim 1, wherein the first transmit power and the second transmit power are not equal.

4. The method of claim 1, wherein the first transmit power is determined to be split among one or more first physical uplink shared channel (PUSCH) antenna ports that are to be used for a first set of PUSCH occasions, and the second transmit power is determined to be split among one or more second PUSCH antenna ports that are to be used for a second set of PUSCH occasions.

5. The method of claim 4, wherein the first set of PUSCH occasions are time division multiplexed or frequency division multiplexed with the second set of PUSCH occasions.

6. The method of claim 4, wherein the first transmit power is determined to be split equally among the one or more first PUSCH antenna ports, and the second transmit power is determined to be split equally among the one or more second PUSCH antenna ports.

7. The method of claim 4, wherein the first set of PUSCH occasions is associated with at least one of a first time division resource allocation, a first frequency division resource allocation, a first beam indication, or a first closed loop index, and the second set of PUSCH occasions is associated with at least one of a second time division resource allocation, a second frequency division resource allocation, a second beam indication, or a second closed loop index.

8. The method of claim 1, wherein the first transmit power is determined to be split among one or more first physical uplink shared channel (PUSCH) antenna ports associated with a first set of layers used for a PUSCH occasion, and the second transmit power is determined to be split among one or more second PUSCH antenna ports associated with a second set of layers used for the PUSCH occasion.

9. The method of claim 8, wherein the first set of layers and the second set of layers are used for a non-coherent joint transmission of the uplink transmission in the PUSCH occasion.

10. The method of claim 8, wherein the first transmit power is determined to be split equally among the one or more first PUSCH antenna ports, and the second transmit power is determined to be split equally among the one or more second PUSCH antenna ports.

11. The method of claim 8, wherein the first set of layers is associated with at least one of a first demodulation reference signal (DMRS) port group, a first beam indication, or a first closed loop index, and the second set of layers is associated with at least one of a second DMRS port group, a second beam indication, or a second closed loop index.

12. The method of claim 8, wherein a first power scaling value is associated with the first set of layers, and a second power scaling value is associated with the second set of layers.

13. The method of claim 1, wherein the first transmit power is determined to be split among one or more first physical uplink shared channel (PUSCH) antenna ports associated with a first group of PUSCH antenna ports used for a PUSCH occasion, and the second transmit power is determined to be split among one or more second PUSCH antenna ports associated with a second group of PUSCH antenna ports used for the PUSCH occasion.

14. The method of claim 13, wherein the first group of PUSCH antenna ports and the second group of PUSCH antenna ports are used for a joint transmission of the uplink transmission in the PUSCH occasion.

15. The method of claim 13, wherein the first transmit power is determined to be split equally among the one or more first PUSCH antenna ports, and the second transmit power is determined to be split equally among the one or more second PUSCH antenna ports.

16. The method of claim 13, wherein the first group of PUSCH antenna ports is associated with at least one of a first PUSCH antenna port group identifier, a first beam indication, or a first closed loop index, and the second group of PUSCH antenna ports is associated with at least one of a second PUSCH antenna port group identifier, a second beam indication, or a second closed loop index.

17. The method of claim 13, wherein a first power scaling value is associated with the first group of PUSCH antenna ports, and a second power scaling value is associated with the second group of PUSCH antenna ports.

18. A user equipment (UE) for wireless communication, comprising:
a memory; and
one or more processors operatively coupled to the memory, the one or more processors configured to cause the UE to:
determine, for an uplink transmission that is to use multiple antenna panels, a first power splitting for a first transmit power associated with a first antenna panel of the multiple antenna panels, and a second power splitting for a second transmit power associated with a second antenna panel of the multiple antenna panels; and
transmit the uplink transmission using the multiple antenna panels according to the first power splitting for the first antenna panel and the second power splitting for the second antenna panel.

19.-20. (canceled)

21. The UE of claim 18, wherein the first transmit power is to be split among one or more first physical uplink shared channel (PUSCH) antenna ports that are to be used for a first set of PUSCH occasions, and the second transmit power is to be split among one or more second PUSCH antenna ports that are to be used for a second set of PUSCH occasions.

22. The UE of claim 21, wherein the first set of PUSCH occasions are time division multiplexed or frequency division multiplexed with the second set of PUSCH occasions.

23. The UE of claim 21, wherein the first transmit power is to be split equally among the one or more first PUSCH antenna ports, and the second transmit power is to be split equally among the one or more second PUSCH antenna ports.

24. The UE of claim 18, wherein the first transmit power is to be split among one or more first physical uplink shared channel (PUSCH) antenna ports associated with a first set of layers used for a PUSCH occasion, and the second transmit power is to be split among one or more second PUSCH antenna ports associated with a second set of layers used for the PUSCH occasion.

25. The UE of claim 24, wherein the first set of layers and the second set of layers are used for a non-coherent joint transmission of the uplink transmission in the PUSCH occasion.

26. The UE of claim 24, wherein the first transmit power is to be split equally among the one or more first PUSCH antenna ports, and the second transmit power is to be split equally among the one or more second PUSCH antenna ports.

27. The UE of claim 24, wherein a first power scaling value is associated with the first set of layers, and a second power scaling value is associated with the second set of layers.

28. The UE of claim 18, wherein the first transmit power is to be split among one or more first physical uplink shared channel (PUSCH) antenna ports associated with a first group of PUSCH antenna ports used for a PUSCH occasion, and the second transmit power is to be split among one or more second PUSCH antenna ports associated with a second group of PUSCH antenna ports used for the PUSCH occasion.

29. The UE of claim 28, wherein the first group of PUSCH antenna ports and the second group of PUSCH antenna ports are used for a joint transmission of the uplink transmission in the PUSCH occasion.

30. The UE of claim 28, wherein the first transmit power is to be split equally among the one or more first PUSCH antenna ports, and the second transmit power is to be split equally among the one or more second PUSCH antenna ports.

31. The UE of claim 28, wherein a first power scaling value is associated with the first group of PUSCH antenna ports, and a second power scaling value is associated with the second group of PUSCH antenna ports.

32. An apparatus for wireless communication, comprising:
means for determining, for an uplink transmission that is to use multiple antenna panels, a first power splitting for a first transmit power associated with a first antenna panel of the multiple antenna panels, and a second power splitting for a second transmit power associated with a second antenna panel of the multiple antenna panels; and
means for transmitting the uplink transmission using the multiple antenna panels according to the first power splitting for the first antenna panel and the second power splitting for the second antenna panel.
